(19) United States
(12) Patent Application Publication
(10) Pub. No.: US 2025/0191229 A1
(43) Pub. Date: Jun. 12, 2025

(54) COLOR COMPARING METHOD AND COLOR COMPARING DEVICE

(71) Applicant: SEIKO EPSON CORPORATION, TOKYO (JP)

(72) Inventor: Takashi TOYA, Chino-shi (JP)

(21) Appl. No.: 18/973,330

(22) Filed: Dec. 9, 2024

(30) Foreign Application Priority Data
Dec. 8, 2023 (JP) 2023-207590

(51) Int. Cl. G06T 7/90; G06T 7/00; G06T 7/60

(52) U.S. Cl. CPC G06T 7/90; G06T 7/0002; G06T 7/60; G06T 2207/10024

(57) ABSTRACT

A color comparing device performs: a reference-information acquiring step (step S1) configured to acquire a measured color value at a plurality of reference points in a reference item containing a color irregularity; a target-information acquiring step (step S2) configured to acquire a measured color value at a plurality of measurement points in a target object; a calculating step (step S4) configured to combine the reference points and the measurement points to calculate a Euclidean distance on a color space coordinate between the reference points and the measurement points that are combined; and a determining step (step S6) configured to compare a predetermined threshold value and the Euclidean distance calculated on a basis of at least a combination from among combinations of the reference points and the measurement points to determine whether or not a color of the reference item and a color of the target object are similar.

The present application is based on, and claims priority from JP Application Serial Number 2023-207590, filed on Dec. 8, 2023, the disclosure of which is hereby incorporated by reference herein in its entirety.

### BACKGROUND

### 1. Technical Field

The present disclosure relates to a color comparing method and a color comparing device.

### 2. Related Art

Typically, there is a technique of evaluating a color of a target object by making comparison with a color of a reference item. For example, JP-A-2006-292693 extracts color data (for example, a color difference or brightness) from an original image serving as the reference item and a copied image serving as the target object, and makes comparison in terms of a Mahalanobis distance of the color data to obtain the similarity of the copied image with respect to the original image.

However, in a case of the method described in JP-A-2006-292693, when color irregularities exist in the reference item, there is a possibility that correct determination cannot be made as to whether or not the color is similar between the reference item and the target object.

### SUMMARY

A color comparing method according to the present disclosure includes a reference-information acquiring step for acquiring a measured color value at a plurality of reference points in a reference item containing a color irregularity, a target-information acquiring step for acquiring a measured color value at a plurality of measurement points in a target object, a calculating step for combining the reference points and the measurement points to calculate a Euclidean distance on a color space coordinate between the reference points and the measurement points that are combined, and a determining step for comparing a predetermined threshold value and the Euclidean distance calculated on a basis of at least a combination from among combinations of the reference points and the measurement points to determine whether or not a color of the reference item and a color of the target object are similar.

A color comparing device according to the present disclosure includes a reference-information acquiring unit configured to acquire a measured color value at a plurality of reference points in a reference item containing a color irregularity, a target-information acquiring unit configured to acquire a measured color value at a plurality of measurement points in a target object, a calculating unit configured to combine the reference points and the measurement points to calculate a Euclidean distance on a color space coordinate between the reference points and the measurement points that are combined, and a determining unit configured to compare a predetermined threshold value and the Euclidean distance calculated on a basis of at least a combination from among combinations of the reference points and the measurement points to determine whether or not a color of the reference item and a color of the target object are similar.

### BRIEF DESCRIPTION OF THE DRAWINGS

FIG. 1 is a block diagram illustrating the schematic configuration of a color comparing device according to one embodiment of the present disclosure.

FIG. 2 is a cross-sectional view illustrating the schematic configuration of a spectroscope according to the present embodiment.

FIG. 3 is a flowchart used to describe a color comparing method according to the present embodiment.

FIG. 4 is a diagram illustrating an example of a plurality of reference points in a reference item.

FIG. 5 is a diagram illustrating an example of a plurality of measurement points in a target object.

### DESCRIPTION OF EMBODIMENTS

One embodiment according to the present disclosure will be described.

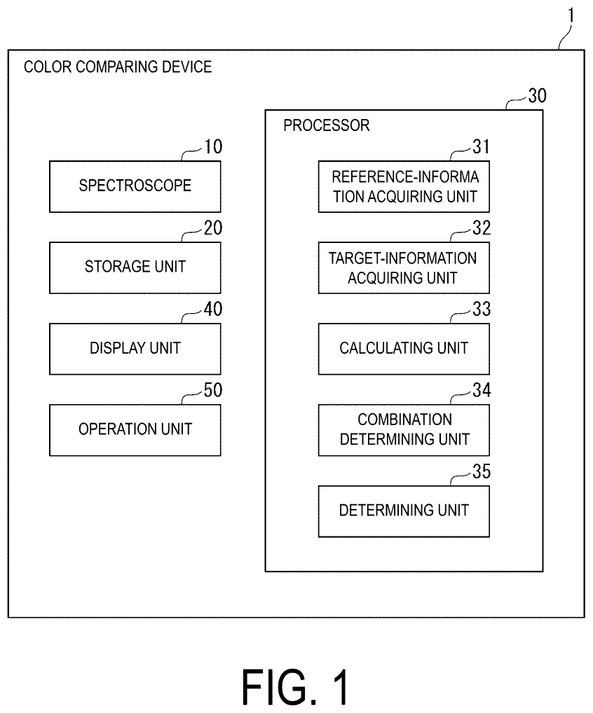

FIG. 1 is a block diagram schematically illustrating a color comparing device 1 according to the present embodiment. The color comparing device 1 includes a spectroscope 10, a storage unit 20, a processor 30, a display unit 40, and an operation unit 50. This color comparing device 1 measures a color of a target object, and performs color comparison of the target object with respect to a reference item.

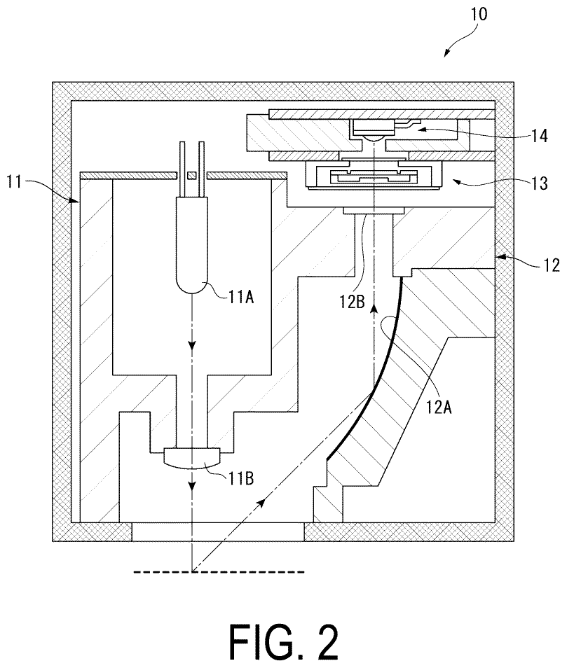

FIG. 2 is a diagram illustrating one example of a spectroscope 10 mounted at the color comparing device 1.

The spectroscope 10 includes a light source unit 11, a light-guiding unit 12, a spectral filter 13, and a light-receiving unit 14.

The light source unit 11 includes a light source 11A and a condensing unit 11B. Light outputted from the light source 11A is emitted to the target object through the condensing unit 11B.

The light-guiding unit 12 includes a reflecting mirror 12A and a bandpass filter 12B. The bandpass filter 12B is a filter configured to cause light having a predetermined wavelength region from the incident light to enter. The bandpass filter 12B transmits light having a wavelength in a visible-light range, and blocks light having a wavelength other this wavelength. The light reflected by the target object is reflected in the reflecting mirror 12A, and passes through the bandpass filter 12B to enter the spectral filter 13.

The spectral filter 13 is a filter configured to transmit light having a predetermined wavelength from the incident light, and is able to switch the transmitting wavelength. For example, the spectral filter 13 is a Fabry-Perot etalon, and includes a pair of reflective films disposed so as to be opposed to each other. The spectral filter 13 changes the distance between the pair of reflective films to switch the transmitting wavelength. Note that, in addition to the etalon element, the spectral filter 13 may be other filters such as an acousto-optic tunable filter (AOTF) or a liquid crystal tunable filter (LCTF) or the like.

The light-receiving unit 14 is, for example, a photodiode. The light-receiving unit 14 receives light that has passed through the spectral filter 13, and outputs a detection signal corresponding to the amount of received light. Note that the detection signal outputted by the light-receiving unit 14 is inputted into the processor 30 through a signal processing unit (for example, an I-V converter, an amplifier, and an AD converter) that is not illustrated in the drawing.

The storage unit 20 in FIG. 1 holds various types of programs used to control the color comparing device 1 and various types of data. For example, the various types of programs held in the storage unit 20 include a spectrum-measurement control program used to control the spectroscope 10, a color comparing program used to perform color comparison of the target object on the basis of a result of spectrum measurement, and the like.

In addition, the various types of data held in the storage unit 20 include table data used to drive the spectral filter 13 described above, a plurality of reference item data, and the like.

The reference item data is a dataset corresponding to the reference item, and includes measured color values at plurality of reference points A₁ to Aₘ in the reference item, the measured-color average value, the number of reference points A₁ to Aₘ, and a threshold value Lth. It is only necessary that the threshold value Lth is a binary value set in advance through experiments or simulations or the like and on the basis of a desired level of color comparison. As the threshold value Lth reduces, color comparison at a higher similarity level (for example, determination of the sameness of colors) is performed. The reference item is any given item containing a color irregularity, and includes, for example, a natural object such as a plant, an image such as a design indicating a color irregularity.

In addition, the reference item data may include any given data indicating the positions of the reference points A₁ to Aₘ in the reference item. For example, the data may include image data indicating the positions of the reference points A₁ to Aₘ in the reference item.

The processor 30 is comprised, for example, of an arithmetic circuit such as a central processing unit (CPU), and achieves various types of functions by reading various types of programs held in the storage unit 20 to implement them. In the present embodiment, the processor 30 reads a color comparing program held in the storage unit 20 to implement it, thereby functioning as a reference-information acquiring unit 31, a target-information acquiring unit 32, a calculating unit 33, a combination determining unit 34, and a determining unit 35, as illustrated in FIG. 1. These individual functions will be described later.

The display unit 40 is, for example, a display, and displays, to a user, a measurement guide or color determination result or the like. The operation unit 50 is, for example, a key or touch display or the like, and receives an input operation made by a user.

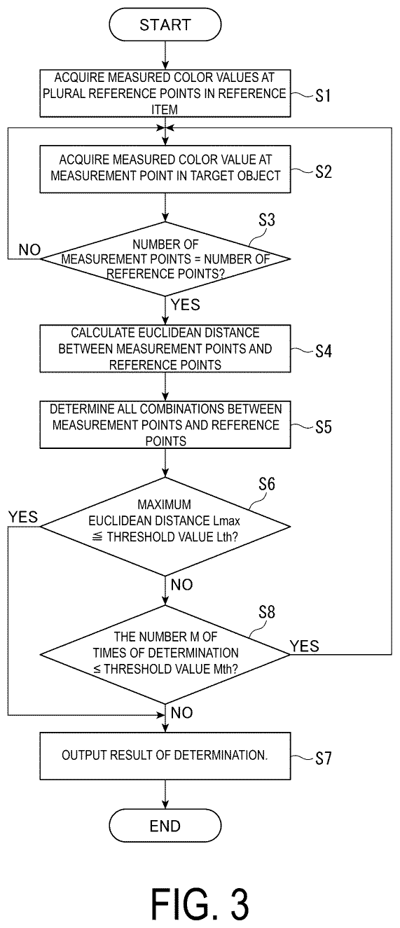

Next, a color comparing method in the color comparing device 1 according to the present embodiment will be described. FIG. 3 is a flowchart showing the color comparing method according to the present embodiment.

First, the reference-information acquiring unit 31 selects reference item data in the storage unit 20 in response to the input operation by a user, and acquires individual measured color values at the plurality of reference points A₁ to Aₘ in the reference item data (step S1).

Next, when the spectroscope 10 is set to a target object and an operation for performing spectrum measurement is inputted by a user, the target-information acquiring unit 32 controls the spectroscope 10 to acquire a measured color value at the measurement point Bₙ in the target object (step S2). Here, with control of the target-information acquiring unit 32, the spectroscope 10 changes the transmitting wavelength of the spectral filter 13 at wavelength intervals that are set in advance, and measures spectral data at the measurement point Bₙ in a visible-light range. In addition, the target-information acquiring unit 32 calculates the measured color value at this measurement point Bₙ on the basis of the spectral data at the measurement point Bₙ. As for the measured color value, it is possible to use any given color system such as a XYZ value or a L*a*b* value, for example. The measured color value corresponding to the measurement point Bₙ is stored in a data reference region for color determination in the storage unit 20.

Note that, as for the method of calculating the measured color value from the spectral data, it is possible to use a known technique such as JP-A-2017-49163. In addition, before step S2, it may be possible to perform calibration using a white standard board or the like.

Before step S2 described above is performed, the display unit 40 may display data indicating individual positions of the reference points A₁ to Aₘ in the reference item. In this case, a user looks up the data displayed on the display unit 40, and sets the spectroscope 10 to the target object such that the positional relationship of the plurality of reference points A₁ to Aₘ in the reference item and the positional relationship of the plurality of measurement points B₁ to Bₘ in the target object are equal to each other, to determine the arrangement of the measurement point Bₙ. Here, the term “equal” is used for the purpose of avoiding occurrence of large discrepancy in colors in a combination of the reference point Aₙ and the measurement point Bₙ determined in step S5 that will be described later, and no strict accuracy of position is not demanded.

After this, the target-information acquiring unit 32 compares the number of reference points A₁ to Aₘ in the reference item acquired in step S1 with the number of color-measurement points Bₙ in the target object for which measurement has been done (step S3).

When the number of color-measurement points Bₙ in the target object is less than the number of reference points A₁ to Aₘ, a guide that prompts measurement in the target object is outputted to the display unit 40 or the like, and the process returns to step S2.

On the other hand, when the number of color-measurement points Bₙ in the target object is equal to the number of reference points A₁ to Aₘ, the target-information acquiring unit 32 ends measurement of the target object, and proceeds to step S4. With this process, it is possible to acquire individual measured color values of the measurement points B₁ to Bₘ, the number of which is equal to the number of the reference points A₁ to Aₘ.

Next, the calculating unit 33 sequentially combines each of the measurement points B₁ to Bₘ with the corresponding one of the reference points A₁ to Aₘ, and calculates the Euclidean distance L, on a color space coordinate, between the reference point Aₙ and the measurement point Bₙ (step S4). That is, the calculating unit 33 creates combinations between the reference points A₁ to Aₘ and the measurement points B₁ to Bₘ in a round-robin manner, and calculates the Euclidean distance L for each of the combinations.

Next, on the basis of the Euclidean distances L calculated in step S4, the combination determining unit 34 determines all the combinations between the plurality of reference points A₁ to Aₘ and the a plurality of measurement points B₁ to Bₘ, that is, the m pieces of combinations, so as to minimize the total sum of the Euclidean distances L of each of the combinations of the measurement points Bₙ and the reference points Aₙ (step S5).

Next, the determining unit 35 selects the maximum Euclidean distance Lmax calculated on the basis of a combination from among the m pieces of combinations between the reference points A₁ to Aₘ and the measurement points B₁ to Bₘ determined in step S5, and determines whether or not this maximum Euclidean distance Lmax is equal to or less than a predetermined threshold value Lth (step S6). This threshold value Lth is a binary value included in the reference item data acquired in step S1, for example.

Note that, in association with step S6 being performed, the determining unit 35 counts up the number M of times of determination held in the storage unit 20.

When the maximum Euclidean distance Lmax is equal to or less than the threshold value Lth (step S6; YES), the determining unit 35 determines that the color of the target object is similar to the color of the reference item. After this, the determining unit 35 outputs the result of determination to the display unit 40 or the like (step S7). Then, the flowchart of FIG. 3 ends.

On the other hand, when the maximum Euclidean distance Lmax is larger than the threshold value Lth (step S6; NO), the determining unit 35 determines whether or not the number M of times of determination held in the storage unit 20 is equal to or less than a predetermined repeating threshold value Mth (step S8). There is no particular limitation as to the repeating threshold value Mth, and any number may be used.

In addition, when the number M of times of determination is equal to or less than the repeating threshold value Mth (step S8; YES), the determining unit 35 outputs a guide for prompting re-measurement to the display unit 40 or the like, and the process returns to step S2. At this time, data regarding the measurement points B₁ to Bₘ used in the immediately preceding color determination is deleted from the data reference region for color determination.

When the number M of times of determination is larger than the repeating threshold value Mth (step S8; NO), the determining unit 35 determines that the color of the target object is not similar to the color of the reference item. After this, the determining unit 35 outputs the result of determination to the display unit 40 or the like (step S7). Then, the flowchart of FIG. 3 ends.

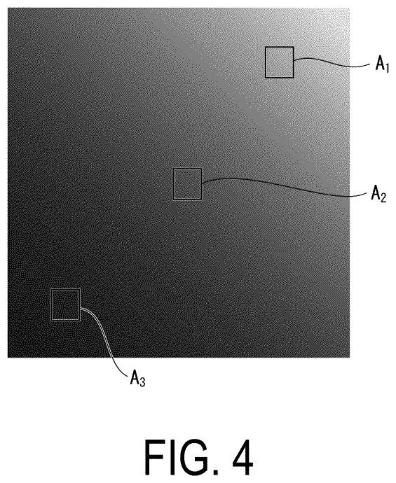

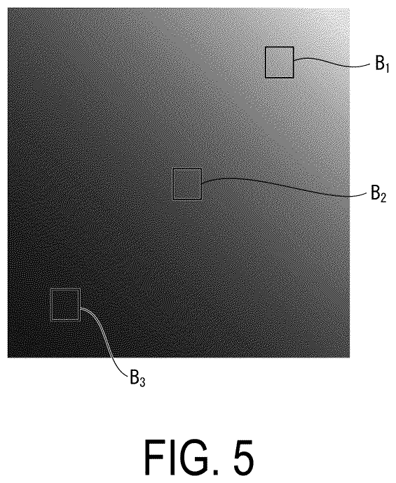

Below, description will be made, as an example, of a case of acquiring individual measured color values at three reference points A₁, A₂, and A₃ (see FIG. 4) and three measurement points B₁, B₂, and B₃ (see FIG. 5) through steps S1 to S3 described above. In step S4 described above, the following Equation (1) can be used to calculate a Euclidean distance L_(A₁−B₁) between the reference point A₁ and the measurement point B₁, for example.

$${L}_{-} ( {A}_{1} - {B}_{1} ) = \sqrt{\begin{matrix}{( L * {\_A}_{1} - L * {\_B}_{1} )}^{2} + ( a * {\_A}_{1} - \\ {a * {\_B}_{1} )}^{2} + {( b * {\_A}_{1} - b * {\_B}_{1} )}^{2}\end{matrix}} \qquad Equation ( 1 )$$

In addition, in step S5 described above, at the time of calculating the total sum S of the Euclidean distances in a case of combining A₁ and B₁, A₂ and B₂, and A₃ and B₃, this total sum S can be calculated using the following Equation (2).

$$S = L\_ ( {A}_{1} - {B}_{1} ) + L\_ ( {A}_{2} - {B}_{2} ) + L\_ ( {A}_{3} - {B}_{3} ) \qquad Formula ( 2 )$$

When three combinations of A₁ and B₁, A₂ and B₂, and A₃ and B₃ are determined in step S5 described above, a combination indicating the maximum value is selected in step S6 described above from among the Euclidean distances L_(A₁−B₁), L_(A₂−B₂), and L_(A₃−B₃). When the Euclidean distance L_(A₁−B₁) indicates the maximum value, it is only necessary to compare this Euclidean distance L_(A₁−B₁) with the predetermined threshold value Lth.

### Effect of the Present Exemplary Embodiment

The color comparing device 1 according to the present embodiment performs: the reference-information acquiring step (step S1) configured to acquire a measured color value at each of the plurality of reference points A₁ to Aₘ in a reference item containing a color irregularity; the target-information acquiring step (step S2) configured to acquire a measured color value at each of the plurality of measurement points B₁ to Bₘ in a target object; the calculating step (step S4) configured to combine the reference point Aₙ and the measurement point Bₙ to calculate a Euclidean distance L on a color space coordinate between the reference point Aₙ and the measurement point Bₙ that are combined; and the determining step (step S6) configured to compare the predetermined threshold value Lth and the Euclidean distance L calculated on the basis of at least a combination from among combinations of the reference points Aₙ and the measurement points Bₙ to determine whether or not a color of the reference item and a color of the target object are similar.

With the present embodiment, the reference point Aₙ is set at locations having various color densities in the reference item containing a color irregularity, and the measurement point Bₙ is set at a plurality of locations. By using individual measured color values at the reference point Aₙ and the measurement point Bₙ in determination, it is possible to entirely determine the color similarity between the reference item and the target object. That is, with the present embodiment, it is possible to appropriately compare colors even when a color irregularity exists in the reference item.

In addition, the present embodiment does not require individual positional coordinates for the reference point Aₙ in the reference item and the measurement point Bₙ in the target object. Thus, it is possible to simply compare the color of the target object with respect to the reference item.

In the present embodiment, it is preferable that the measured color value should be expressed in a L*A*B* color system. This make it possible to perform color comparison close to user's perception.

The color comparing device 1 according to the present embodiment further performs a combination determining step (step S5) configured to determine the combination between the reference point Aₙ and the measurement point Bₙ so as to minimize the total sum of the Euclidean distances L between the reference item and the target object. In the determining step (step S6), the predetermined threshold value Lth is compared with the Euclidean distance L calculated on the basis of at least a combination from among combinations between the reference point Aₙ and the measurement point Bₙ determined in the combination determining step (step S5).

With this configuration, when, in addition to the reference item, the target object contains a color irregularity, it is possible to appropriately combine the reference point Aₙ and the measurement point Bₙ, which makes it possible to appropriately perform color comparison.

In the present embodiment, the determining step (step S6) is configured to compare the threshold value Lth with the maximum Euclidean distance Lmax calculated on the basis of a combination from among the combinations between the reference points and the measurement points determined in the combination determining step (step S5).

With this configuration, colors are compared by using data regarding a combination in which colors are furthest away from each other, from among a plurality of combinations between the reference point Aₙ and the measurement point Bₙ. This makes it possible to entirely determine the color similarity between the reference item and the target object.

In the present embodiment, the reference-information acquiring step (step S1) is configured to acquire, as a set, measured color values at the plurality of reference points A₁ to Aₘ in the reference item, a measured-color average value, the number of measurement points, and the threshold value Lth. With this configuration, it is possible to simply perform color comparison of the present embodiment. For example, this enables a user to select desired reference item data or use the threshold value Lth that fits the reference item.

### Modification Example

The present disclosure is not limited to the embodiment described above, and includes configurations obtained by making modification, improvement, and the like within the scope in which the object of the present disclosure can be achieved.

In the embodiment described above, the reference item data may not include the measured-color average value or the threshold value Lth. In addition, in the embodiment described above, the threshold value Lth is set for each reference item. However, the threshold value Lth may be equal.

In the embodiment described above, the target-information acquiring unit 32 calculates the measured color value at the measurement point Bₙ on the basis of the spectrum acquired from the spectroscope 10. However, the measured color value at the measurement point Bₙ may be acquired from any given database.

### Second Modification Example

In step S6 of the embodiment described above, the maximum Euclidean distance Lmax and the threshold value Lth are compared with each other. However, the present disclosure is not limited to this configuration. For example, it may be possible to compare the threshold value Lth and the average value of Euclidean distances L calculated on the basis of the combinations between the reference points A₁ to Aₘ and the measurement points B₁ to Bₘ determined in step S5, or it may be possible to compare the threshold value Lth and the minimum value of the Euclidean distance L calculated on the basis any combination.

### Third Modification Example

In step S5 of the embodiment described above, all the combinations between the reference points A₁ to Aₘ and the measurement points B₁ to Bₘ are determined so as to minimize the total sum of the Euclidean distances L. However, the present disclosure is not limited to this configuration. For example, in step S2 described above, when the order of measurement of the measurement point Bₙ corresponding to the reference point Aₙ is designated, it may be possible to determine the combinations on the basis of this order of measurement.

### Fourth Modification Example

In the embodiment described above, the spectroscope 10 may be a spectral camera configured to pick up a spectral image. In this case, the target-information acquiring unit 32 may calculate the measured color value at the measurement point Bₙ on the basis of the average value in any given area (for example, 10 pixels×10 pixels) of the spectral image.

Alternatively, instead of the spectroscope 10, it may be possible to use an RGB camera. In this case, the target-information acquiring unit 32 may acquire the measured color value at the measurement point Bₙ on the basis of the captured image.

### Fifth Modification Example

The embodiment described above describes that, in step S2, the positional relationship of the plurality of measurement points B₁ to Bₘ in the target object and the positional relationship of the plurality of reference points A₁ to Aₘ in the reference item are equal to each other. However, the present disclosure is not limited to this. For example, the number of repetitions of measurement in step S5 may be set to be increased to secure the effectiveness of color comparison.

### Sixth Modification Example

In step S1 of the embodiment described above, the reference-information acquiring unit 31 acquires the reference item data such as the measured color value from the storage unit 20. However, the present disclosure is not limited to this configuration. For example, the reference-information acquiring unit 31 may acquire the reference item data from another database that can communicate with the color comparing device 1. In addition, by controlling the spectroscope 10, the reference-information acquiring unit 31 may calculate the measured color value at the reference point Aₙ on the basis of a result of spectrum measurement on the reference item.

### Overview of Present Disclosure

A color comparing method according to the present disclosure includes: a reference-information acquiring step configured to acquire a measured color value at a plurality of reference points in a reference item containing a color irregularity; a target-information acquiring step configured to acquire a measured color value at a plurality of measurement points in a target object; a calculating step configured to combine the reference points and the measurement points to calculate a Euclidean distance on a color space coordinate between the reference points and the measurement points that are combined; and a determining step configured to compare a predetermined threshold value and the Euclidean distance calculated on the basis of at least a combination from among combinations of the reference points and the measurement points to determine whether or not a color of the reference item and a color of the target object are similar.

In the color comparing method according to the present aspect, it is preferable that the measured color value be expressed in a L*A*B* color system.

In the color comparing a method according to the present aspect, it is preferable to employ a configuration in which the color comparing method further includes a combination determining step configured to determine all combinations between the reference points and the measurement points so as to minimize the total sum of the Euclidean distances between the reference item and the target object, and in the determining step, the predetermined threshold value is compared with the Euclidean distance calculated on a basis of at least a combination from among all the combinations between the reference points and the measurement points that have been determined.

In the color comparing a method according to the present aspect, it is preferable that, in the determining step, the threshold value be compared with a maximum Euclidean distance calculated on a basis of a combination from among all combinations between the reference points and the measurement points that are determined in the combination determining step.

In the color comparing a method according to the present aspect, it is preferable that, in the reference-information acquiring step, each measured color value at the plurality of reference points in the reference item, a measured-color average value, the number of the reference points, and the threshold value be acquired as a set.

A color comparing device according to the present disclosure includes: a reference-information acquiring unit configured to acquire a measured color value at a plurality of reference points in a reference item containing a color irregularity; a target-information acquiring unit configured to acquire a measured color value at a plurality of measurement points in a target object; a calculating unit configured to combine the reference points and the measurement points to calculate a Euclidean distance on a color space coordinate between the reference points and the measurement points that are combined together; and a determining unit configured to compare a predetermined threshold value and the Euclidean distance calculated on the basis of at least a combination from among combinations of the reference points and the measurement points to determine whether or not a color of the reference item and a color of the target object are similar.

It is preferable that the color comparing device according to the present aspect further include a display unit configured to display data indicating positions of the reference points in the reference item.

In addition, it is preferable that the color comparing device according to the present aspect further include a display unit configured to display a result of determination by the determining unit.

What is claimed is:

1. A color comparing method comprising:
a reference-information acquiring step for acquiring a measured color value at a plurality of reference points in a reference item containing a color irregularity;
a target-information acquiring step for acquiring a measured color value at a plurality of measurement points in a target object;
a calculating step for combining the reference points and the measurement points to calculate a Euclidean distance on a color space coordinate between the reference points and the measurement points that are combined; and
a determining step for comparing a predetermined threshold value and the Euclidean distance calculated on a basis of at least a combination from among combinations of the reference points and the measurement points to determine whether or not a color of the reference item and a color of the target object are similar.

2. The color comparing method according to claim 1, wherein
the measured color value is expressed in a L*A*B* color system.

3. The color comparing method according to claim 1, further comprising:
a combination determining step for determining all combinations between the reference points and the measurement points so as to minimize a total sum of the Euclidean distance between the reference item and the target object, wherein
in the determining step, the threshold value is compared with the Euclidean distance calculated on a basis of at least a combination from among all the combinations between the reference points and the measurement points that are determined in the combination determining step.

4. The color comparing method according to claim 3, wherein
in the determining step, the threshold value is compared with a maximum Euclidean distance calculated on a basis of a combination from among all combinations between the reference points and the measurement points that are determined in the combination determining step.

5. The color comparing method according to claim 1, wherein
in the reference-information acquiring step, each measured color value at the plurality of reference points in the reference item, a measured-color average value, the number of the reference points, and the threshold value are acquired as a set.

6. A color comparing device comprising:
a reference-information acquiring unit configured to acquire a measured color value at a plurality of reference points in a reference item containing a color irregularity;
a target-information acquiring unit configured to acquire a measured color value at a plurality of measurement points in a target object;
a calculating unit configured to combine the reference points and the measurement points to calculate a Euclidean distance on a color space coordinate between the reference points and the measurement points that are combined; and
a determining unit configured to compare a predetermined threshold value and the Euclidean distance calculated on a basis of at least a combination from among combinations of the reference points and the measurement points to determine whether or not a color of the reference item and a color of the target object are similar.

7. The color comparing device according to claim 6 further comprising:
a display unit configured to display data indicating positions of the reference points in the reference item.

8. The color comparing device according to claim 6 further comprising:
a display unit configured to display a result of determination by the determining unit.
